(19) United States
(12) Patent Application Publication
(10) Pub. No.: US 2004/0019687 A1
(43) Pub. Date: Jan. 29, 2004

(54) Timeout management system, timeout management server and timeout management program storage medium

(75) Inventors: Tetuya Ozawa, Maebashi (JP); Yoshiharu Shimada, Maebashi (JP); Akihiro Sato, Maebashi (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: Fujitsu Limited, Kawasaki (JP)

(21) Appl. No.: 10/326,396

(22) Filed: Dec. 23, 2002

(30) Foreign Application Priority Data
Jul. 26, 2002 (JP) 2002-218197

(51) Int. Cl. G06F 15/16

(52) U.S. Cl. 709/229; 709/203

(57) ABSTRACT

A sense of unity is maintained among a plurality of Web sites provided by a plurality of timeout management servers respectively. A timeout management system 10 includes a plurality of timeout management servers 100 and 200 for providing a service to an access side in response to an access via a communication network 400 based on a temporary access right, and also managing a so-called timeout process, and a client 300 holding the access right in parallel with respect to the plurality of timeout management servers 100 and 200, in which the timeout management server 100 is provided with an access occurrence section for, in response to the access with respect to the timeout management server 100 by the client 300, based on the access right of the client 300, causing the access to occur with respect to the other timeout management server 200.

### BACKGROUND OF THE INVENTION

1. Field of the Invention

The present invention relates to a timeout management system for managing a so-called timeout process, which causes a user to automatically perform logout when a predefined timeout time has elapsed since a time of the user's last access, a timeout management server and a timeout management program storage medium having stored a timeout management program for managing the timeout process.

2. Description of the Related Art

Because of development of the Internet in recent years, a usage form has been increased in which a user accesses a second Web site on a WWW server of other existing corporation, through a first Web site operated by the user's organization which the user belongs to, and receives a service.

For example, the user starts the first Web site of a company which the user belongs to, accesses the second Web site of a corporate pension management organization with which the company, which the user belongs to, is affiliated, the second Web site being linked to the first Web site, and then confirms the user's pension management status, or the like.

In this way, when the user utilizes the first Web site and the second Web site, a system is often used in which the user performs login to a WWW server of the company to open the first Web site on a browser by means of a user authentication system managed by the company which the user belongs to, starts the second Web site on a WWW server of the corporate pension management organization in a screen of the first Web site displayed in the browser, and performs the login by means of a user authentication system managed by the corporate pension management organization. In order to enable such a system, in the WWW server of the company which the user belongs to, the Web site of the corporate pension management organization, or the like, software parts for performing explicitly the login and logout are prepared, and such software parts are invoked on the browser to perform the login and the logout.

In addition, in the system in which the login is performed with respect to the first WWW server by means of a first user authentication and then the login is performed with respect to the second WWW server by means of a second user authentication, the user needs to input information for performing the user authentication, such as a user ID or a password, into each of the first and second WWW servers. So since it is cumbersome to perform the user authentication every time the user utilizes the individual WWW server, there is also a system in which the user authentication information inputted by the user once is stored in a hard disk, a memory or the like, and the information stored in the hard disk, the memory or the like is used for the user authentication on and after the second time in order to reduce an effort for the user authentication.

In any of the above described systems, the user may use the service on each Web site without being conscious that each Web site exists on the separate WWW server, but with feeling as if the first Web site and the second Web site are one as a whole.

By the way, the WWW server in the system in which the user performs the login by means of the user authentication, typically performs a timeout process for causing the user to automatically perform the logout when a predefined timeout time has elapsed since a time of the user's last access, in the case when the user forgets to perform the logout, in order to keep the user's personal information or the like from being viewed by a third person. Thereby the WWW server in this system has a function as a timeout management server. Particularly, in the Web site of the corporate pension management organization or the like in which privacy is regarded, the timeout time may be much shorter than that in the Web site operated by an ordinary company for their employees.

When such a timeout process is performed, while the user, from the first Web site of the company which the user belongs to, starts and performs the login to the second Web site of the corporate pension management organization linked to the first Web site, if the user accesses the first Web site and is receiving the service, the timeout process is automatically performed as the timeout time has elapsed on the second Web site, and a termination screen is displayed on a Web screen of the corporate pension management organization, thereby the user authentication is deleted. When the user authentication is deleted in this way, it is necessary to perform the user authentication again on the Web screen of the second Web site, in order for the user to access the second Web site again. For example, when the timeout time of the WWW server of the company which the user belongs to is 30 minutes, and the timeout time of the WWW server of the corporate pension management organization is 5 minutes, while the second Web site of the corporate pension management organization is started, if an input process is performed for more than 5 minutes on the first Web site of the company which the user belongs to, suddenly the timeout of the WWW server of the corporate pension management organization occurs and the termination screen is displayed on a page of the second Web site, thereby the user authentication is deleted. Then, if the user accesses the second Web site again, it is necessary to perform the user authentication again on the Web screen of the corporate pension management organization, and also it is necessary for the user to perform an operation unfinished by the user on the second Web site before the timeout process, again from the beginning. Thereby, a sense of unity between the first Web site and the second Web site is lost, and a problem arises that, in spite of the fact that the user utilizes a single management system from the point of view of the user, the timeout process is performed separately in each part in the system.

Such a problem similarly occurs even in the case where the above described system is employed which eliminates the user authentication with respect to the second WWW server, by means of the user authentication information inputted with respect to the first WWW server.

When such a problem occurs, the user has to access the system in consideration of the timeout time in each part within the system or the like, thereby the system becomes very cumbersome to use.

### SUMMARY OF THE INVENTION

In view of the above described matters, it is an object of the present invention to provide a timeout management system in which a timeout process may be managed so that a sense of unity is maintained among services provided by a plurality of timeout management servers respectively, a timeout management server, and a timeout management program storage medium having stored a timeout management program in which the timeout process may be managed in this way.

The timeout management system of the present invention for achieving the above described object is characterized by including: a plurality of timeout management servers for providing a service to an access side in response to an access via a communication network based on a temporary access right, and also depriving of the access right when the access based on the access right halts for a predetermined timeout time since a last access;

a client holding the access right in parallel with respect to the plurality of timeout management servers; and

an access occurrence section for, in response to the access by the client with respect to one timeout management server of the above described plurality of timeout management servers, based on the access right of the client, causing the access to occur with respect to the other timeout management server besides the one timeout management server of the above described plurality of timeout management servers.

According to the timeout management system of the present invention, when the client holding the access right in parallel with respect to the plurality of timeout management servers accesses the one timeout management server, the access is caused to occur with respect to the other timeout management server, thereby the timeout is avoided also with respect to the server besides the server of a site for which a user of the client is conscious of the access, so that the sense of unity is maintained among the services provided by the plurality of timeout management servers respectively.

Though the access occurrence section in the timeout management system of the present invention may access the other timeout management system by itself, the above described access occurrence section preferably exists in the timeout management server to perform the access with respect to the other timeout management server by means of the above described client. In such a configuration, the timeout management system of the present invention may be structured only with improvement on the server side.

In addition, the timeout management system of the present invention is preferably provided with a timeout time unification section for altering the respective timeout times in the above described plurality of timeout management servers so as to be coincident with one another. Provided with such a timeout time unification section, timings of the respective timeout processes in the above described plurality of timeout management servers are coincident with one another, thereby a stronger sense of unity is provided.

Here, the above described timeout time unification section desirably sets the timeout time for the timeout management server providing the service of a particular type, as a different timeout time than the timeout time unified among the plurality of timeout management servers.

Provided with such a timeout time unification section, the timeout management system may also be operated such that, for example, the timeout time may be reset for each page structuring a Web site, the timeout time is unified when a page having a lower security level is requested, and another timeout time is set when a page having a higher security level is requested. Thereby, when a special page is displayed, a security problem may be prevented from occurring in which, for example, a stranger views some private information while the user leaves his seat, or the like.

Furthermore, the above described timeout time unification section preferably alters the timeout time if a particular authentication ID is obtained from the client.

Provided with such a timeout time unification section, the timeout management system may set whether or not the alteration of the timeout time is allowed for each user. Thereby, a user type allowed for the alteration of the timeout time or the like may be set according to a security policy of an operator operating the timeout management server.

The timeout management server of the present invention for attaining the above described object, including: an access authorization section for authorizing a client which has issued an application, for a temporary access right, in response to the application via a communication network; a service providing section for providing a service to the client in response to an access by the client holding the access right via the communication network; and a timeout process section for, when the access based on the access right authorized for a client by the access authorization section halts for a predetermined timeout time since a last access, depriving the client of the access right,

is characterized in that the timeout management server includes an access occurrence section for, in response to the access with respect to the above described service providing section by the client which the above described access authorization section authorizes for the temporary access right while the other timeout management server also authorizes for the temporary access right, based on the access right of the client, causing the access to occur with respect to the other timeout management server.

The timeout management program storage medium of the present invention for attaining the above described object, incorporated in a computer, the timeout management program storage medium having stored the timeout management program for operating the computer as a timeout management server, the timeout management server including: an access authorization section for authorizing a client which has issued an application, for a temporary access right, in response to the application via a communication network; a service providing section for providing a service to the client in response to an access by the client holding the access right via the communication network; and a timeout process section for, when the access based on the access right authorized for a client by the access authorization section halts for a predetermined timeout time since a last access, depriving the client of the access right,

is characterized in that the timeout management program storage medium stores the timeout management program for operating the above described computer as the timeout management server, the timeout management server including an access occurrence section for, in response to the access with respect to the service providing section by the client which the above described access authorization section authorizes for the temporary access right while the other timeout management server also authorizes for the temporary access right, based on the access right of the client, causing the access to occur with respect to the other timeout management server.

It should be noted that, though for the timeout management server and the timeout management program as referred to in the present invention, only their basic forms are shown herein in order simply to avoid duplication, the timeout management server and the timeout management program as referred to in the present invention include not only the timeout management server or the like in the above described basic forms, but also the timeout management server or the like in a variety of forms corresponding to each form of the above described timeout management system.

In addition, in the above described timeout management server and the above described timeout management program of the present invention, components for structuring them are named identically to each other, such as the access authorization section or the timeout process section. However, in the case of the timeout management program, the components refer to software for performing such an operation, while in the case of the timeout management server, the components refer to such things including hardware.

In addition, in the components, such as the timeout process section or the like, for structuring the timeout management program of the present invention, a single program part may be responsible for a function of one of the components, a plurality of program part may be responsible for the function of one of the components, or the single program part may be responsible for the functions of a plurality of components. In addition, these components may perform such operation by themselves, or may instruct the other program or program part incorporated in the computer to perform such operation.

### BRIEF DESCRIPTION OF THE DRAWINGS

FIG. 1 is a typical diagram showing a computer network to which an embodiment of the present invention is applied;

FIG. 2 shows an embodiment of a timeout management program storage medium of the present invention;

FIG. 3 is a functional block diagram of an embodiment of a timeout management server of the present invention;

FIG. 4 shows an interaction with information or the like in an operation of a timeout management system of the present embodiment;

FIG. 5 is a flowchart showing a former part of a procedure in a third phase;

FIG. 6 is a flowchart showing a latter part of a procedure in the third phase;

FIG. 7 shows a basic configuration of a screen displayed on a client;

FIG. 8 shows a login state;

FIG. 9 shows the login state only with respect to a first server;

FIG. 10 shows the login state also with respect to a second server 200;

FIG. 11 shows a fourth frame; and

FIG. 12 shows a state in which the fourth frame is utilized.

### DETAILED DESCRIPTION OF THE PREFERRED EMBODIMENTS

An embodiment of the present invention will be described below.

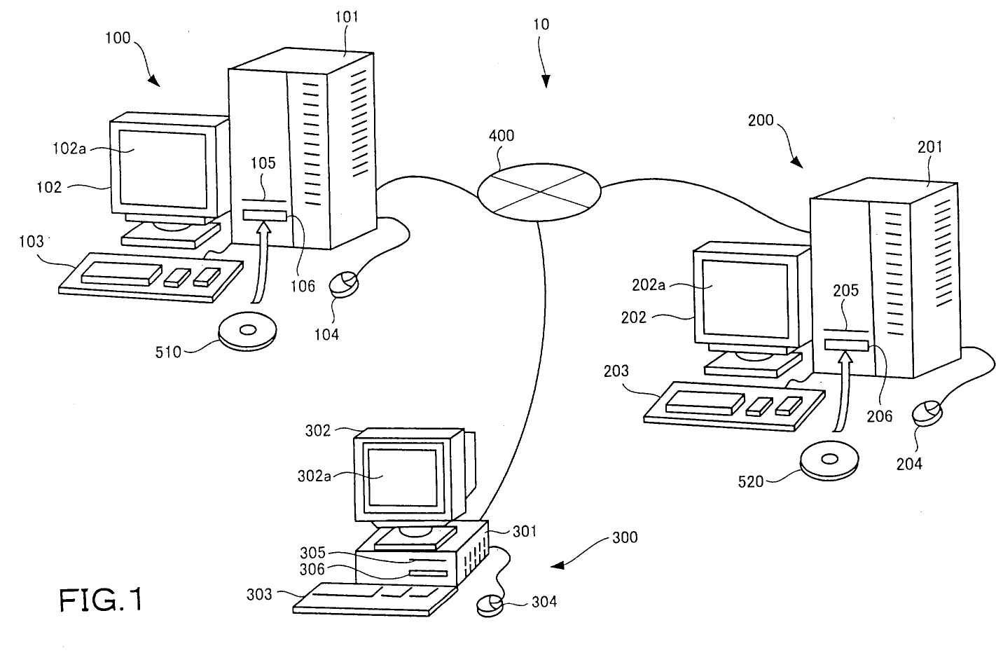

FIG. 1 is a typical diagram showing a computer network to which an embodiment of the present invention is applied.

In FIG. 1, three computers 100, 200 and 300 are illustratively shown and these computers 100, 200 and 300 are connected to one another via a communication network 400, which is represented by the Internet, to form a computer network 10. The two computers 100 and 200 of these computers 100, 200 and 300 are so-called server machines for operating as timeout management servers in the present invention, and in FIG. 1, each of the two computers 100 and 200 corresponds to an embodiment of the timeout management server of the present invention. In addition, the computer 300 of the three computers 100, 200 and 300 illustrated in FIG. 1 is a so-called client machine for operating as a client in the present invention. An embodiment of a timeout management system of the present invention is structured on the computer network 10 including these computers 100, 200 and 300.

It should be noted that though many other computers are included in the computer network 10 in addition to the three computers 100, 200 and 300, the three computers 100, 200 and 300 illustrated herein will be used to represent these many computers in the following description, and they may be noted as a server 100, a server 200 and a client 300 for the convenience of the description.

Each of the computers 100, 200 and 300 is provided with a CPU, a main memory, a hard disk, each of bodies 101, 201 and 301 with a communication board or the like included therein, each of displays 102, 202 and 302 for displaying an image or a string on each of display screens 102a, 202a and 302a according to an instruction from each of the bodies 101, 201 and 301, each of keyboards 103, 203 and 303 for inputting a user's instruction into each of the computers 100, 200 and 300, each of mice 104, 204 and 304 for designating an arbitrary position on each of the display screens 102a, 202a and 302a to input the instruction depending on an icon or the like displayed at that position on the designation.

It should be noted that for the computer 300 as the client machine of the three computers 100, 200 and 300, the display 302, the keyboard 303 or the mouse 304 are used by the user in a normal operation, and on the other hand, for the computers 100 and 200 as the server machines, the displays 102 and 202, the keyboards 103 and 203 or the mice 104 and 204 are used in an emergency, such as the case where an administrator performs maintenance or the like.

In addition, in appearance, each of the bodies 101, 201 and 301 of each of the computers 100, 200 and 300 further has each of FD insertion slots 105, 205 and 305 to be loaded with flexible disks, and each of CD-ROM insertion slots 106, 206 and 306 to be loaded with CD-ROMs 510 and 520. Also, each of the bodies 101, 201 and 301 includes a flexible disk drive and a CD-ROM drive for driving to access the flexible disks or the CD-ROMs 510 and 520 loaded via the insertion slots 105 and 106, 205 and 206, and 305 and 306, respectively.

In FIG. 1, an example of a timeout management program of the present invention is stored in the CD-ROMs 510 and 520, the CD-ROMs 510 and 520 are loaded via the CD-ROM insertion slots 106 and 206 into the bodies 101 and 201 of the server machines, and then the timeout management program stored in the CD-ROMs 510 and 520 is installed into the hard disks of the server machines by means of the CD-ROM drives. When the timeout management program installed in the hard disks is started, the server machines operate as an embodiment of a timeout management device of the present invention, thereby an embodiment of the timeout management system of the present invention is structured on the computer network 10.

The timeout management program stored in the CD-ROMs 510 and 520 is installed into the hard disk of the computer as described above. The hard disk also corresponds to one form of a timeout management program storage medium of the present invention.

In addition, when the timeout management program is downloaded into the flexible disk, the flexible disk also corresponds to an embodiment of the timeout management program storage medium of the present invention.

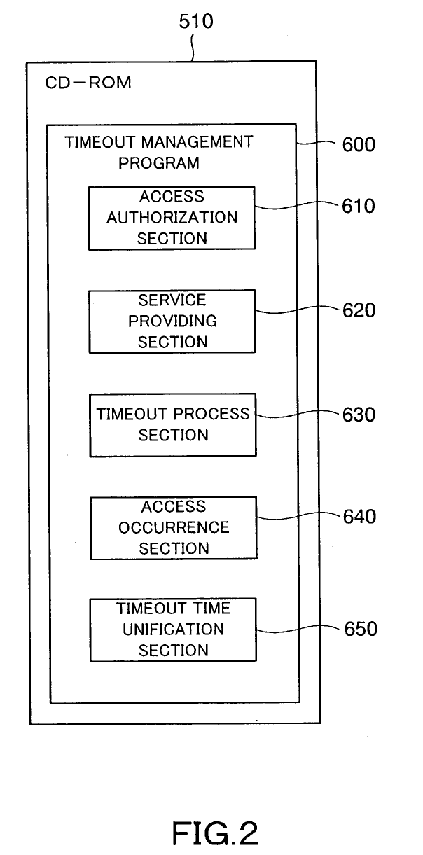

FIG. 2 shows an embodiment of the timeout management program storage medium of the present invention. In FIG. 2, this timeout management program 600 is stored in the CD-ROM 510.

The timeout management program 600 is executed in the computers 100 and 200 as shown in FIG. 1, causes the computers 100 and 200 to operate as the timeout management servers for managing a so-called timeout process, and has an access authorization section 610, a service providing section 620, a timeout process section 630, an access occurrence section 640 and a timeout time unification section 650. Operations of each element of the timeout management program 600 will be described below.

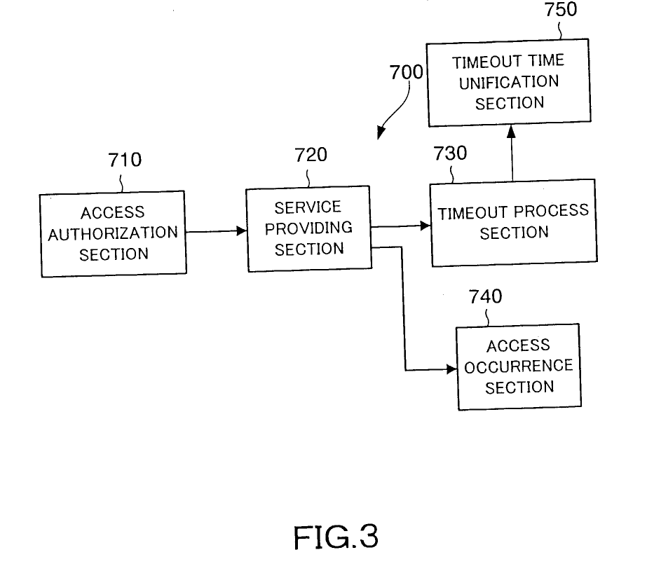

FIG. 3 is a functional block diagram of an embodiment of the timeout management server of the present invention.

This timeout management server 700 is configured by the timeout management program 600 in FIG. 2 being installed into the computers 100 and 200 as shown in FIG. 1 to be executed.

The timeout management server 700 is configured with an access authorization section 710, a service providing section 720, a timeout process section 730, an access occurrence section 740 and a timeout time unification section 750. The access authorization section 710, the service providing section 720, the timeout process section 730, the access occurrence section 740 and the timeout time unification section 750 correspond to the access authorization section 610, the service providing section 620, the timeout process section 630, the access occurrence section 640 and the timeout time unification section 650 for configuring the timeout management program 600 as shown in FIG. 2, respectively. However, each element in FIG. 3 is configured with a combination of hardware of the computers 100 and 200 as shown in FIG. 1 and an OS or program parts to be executed in the computers, while each element of the timeout management program as shown in FIG. 2 is configured with only the program parts thereof.

Now, each element of the timeout management server 700 as shown in FIG. 3 will be described in addition to each element of the timeout management program 600 as shown in FIG. 2.

The access authorization section 710 configuring the timeout management server 700 accepts an application for login including an authentication ID, a password or the like, from the client 300 as shown in FIG. 1 via the communication network, and authorizes the client 300 for a session ID representing a temporary access right. While the client 300 is authorized for the session ID, the client 300 is in a so-called login state in which any authentication ID or any password is not required for an access with respect to the timeout management server 700.

The service providing section 720 provides a predetermined service in response to the access by the client 300 authorized for the session ID, by means of the session ID.

The timeout process section 730 monitors the access with respect to the service providing section 720 by means of the session ID. If the access by means of the session ID halts for a predetermined timeout time, the timeout process section 730 performs the timeout process for depriving the client of the session ID, in order to avoid any leakage of information or the like in case that the user forgets to perform logout.

When the client is authorized for the session ID by its own access authorization section 710 to be in the login state while the client is also authorized for the session ID to be in the login state in the other timeout management server, if the client accesses the service providing section 720, the access occurrence section 740 causes the access to occur with respect to the other timeout management server authorizing the client 300 for the session ID. In the present embodiment, the access occurrence section 740 causes the client 300 to perform the access with respect to the other timeout management server by giving the client 300 an HTML document in a predetermined form as will be described below.

When the client authorized for the session ID by its own access authorization section 710 to be in the login state performs the login to the other timeout management server, the timeout time unification section 750 unifies the timeout time in its own timeout process section 730 and the timeout time in the other timeout management server. It should be noted that, in the present embodiment, the timeout time unification section 750 causes the client 300 to alter setting of the timeout time of the other timeout management server by giving the client 300 a predetermined instruction.

Next, an operation of the timeout management system of the present embodiment will be described below.

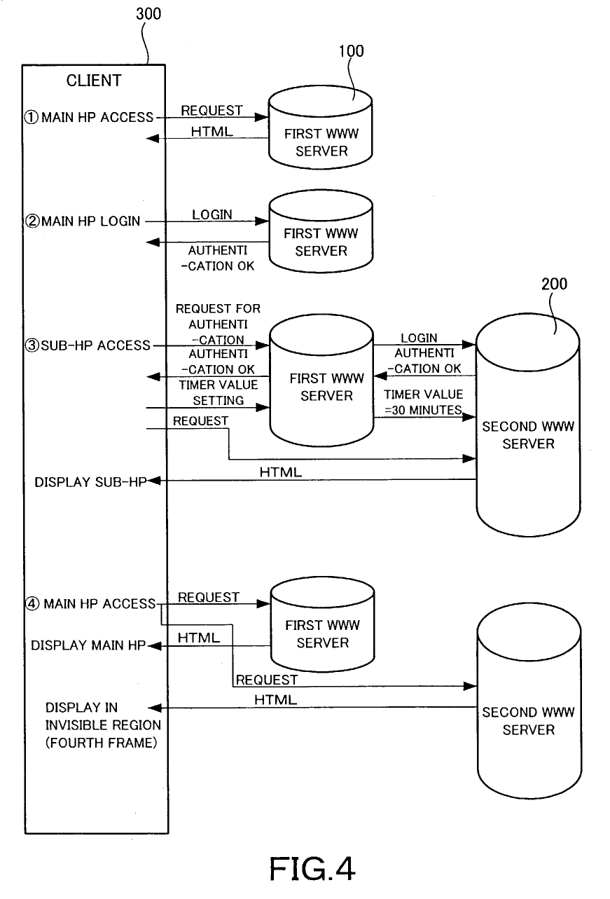

FIG. 4 shows an interaction with information or the like in the operation of the timeout management system of the present embodiment.

In FIG. 4, the two servers 100 and 200, and the client 300 as also shown in FIG. 1 are shown, and the two servers 100 and 200 operate as WWW servers. In the present embodiment, the two servers 100 and 200 provide the service via their homepages (Web sites), and the homepage on the server 100 is linked to the homepage on the server 200. In the following description, in order to distinguish the two servers 100 and 200 from each other, they are referred to as a first server 100 and a second server 200. The user of the service operates the client 300 to access each homepage and receives the service by referring to a page configuring each homepage on a browser on the client 300, or the like.

When the user receives the service, the user receives the service through mainly four phases. The first phase is a phase for finding and accessing the homepage on the first server 100 (a main homepage). The second phase is a phase for performing the login to the main homepage. The third phase is a phase for accessing and performing the login to the homepage on the second server 200 (a sub-homepage) from the main homepage by using the link. The fourth phase is a phase for accessing each homepage to receive the service.

In the first phase, a “request” for requiring a top page is sent from the client 300 to the first server 100, and an HTML document representing the top page (an authentication page) is returned from the service providing section 720 (see FIG. 3) of the first server 100 to the client 300. On the client 300, the authentication page is displayed on the browser, and the user inputs login information via the authentication page.

In the second phase, the login information is sent from the client 300 to the first server 100, and a confirmation result of authentication is returned from the access authorization section 710 (see FIG. 3) of the first server 100 to the client 300.

In the third phase, the client 300 requests the authentication of the second server 200 via the first server 100, and the login information is sent to the second server 200. The authentication result is returned from the access authorization section 710 (see FIG. 3) of the second server 200 through the first server 100 to the client 300. The client 300 accepts the return, and based on the instruction previously given from the timeout time unification section 750 (see FIG. 3) of the first server 100, automatically instructs the second server 200 through the first server 100 to set a timer value as a predetermined timeout time (for example, 30 minutes) to unify the timer value. Then, a “request” for requiring the sub-homepage is sent from the client 300 to the service providing section 720 (see FIG. 3) of the second server 200, and an HTML document representing the sub-homepage is returned from the second server 200 to the client 300. On the client 300, the sub-homepage is displayed by means of the browser.

In the fourth phase, if the user hopes to receive the service, for example, provided on the main homepage, a “request” for requiring provision of the service is sent from the client 300 to the first server 100. Then, based on an instruction given from the access occurrence section 740 (see FIG. 3) of the first server 100, a “request” for requiring dummy information is automatically sent from the client 300 to the second server 200. From the first server 100, an HTML document representing a page for providing the service is returned to the client 300, and on the client 300, the page for providing the service is displayed. In addition, from the second server 200, an HTML document representing the dummy information is returned to the client 300, and on the client 300, the dummy information is displayed in an invisible region as will be described below. Since such dummy information is required of the second server 200, even if the service is continued to be utilized on the homepage on the first server 100, the timeout process on the homepage on the second server 200 is avoided so that a sense of unity is maintained between the main homepage and the sub-homepage.

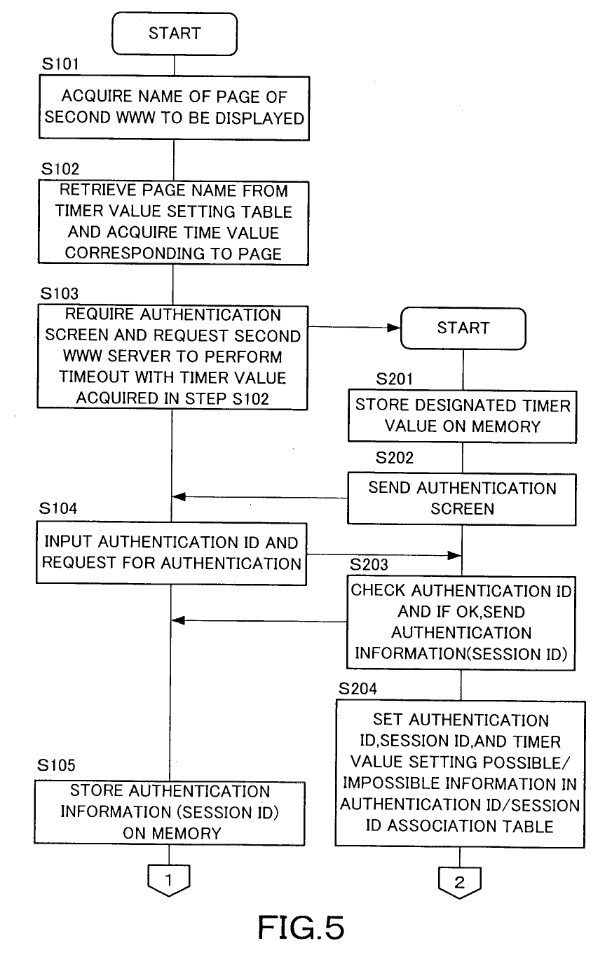

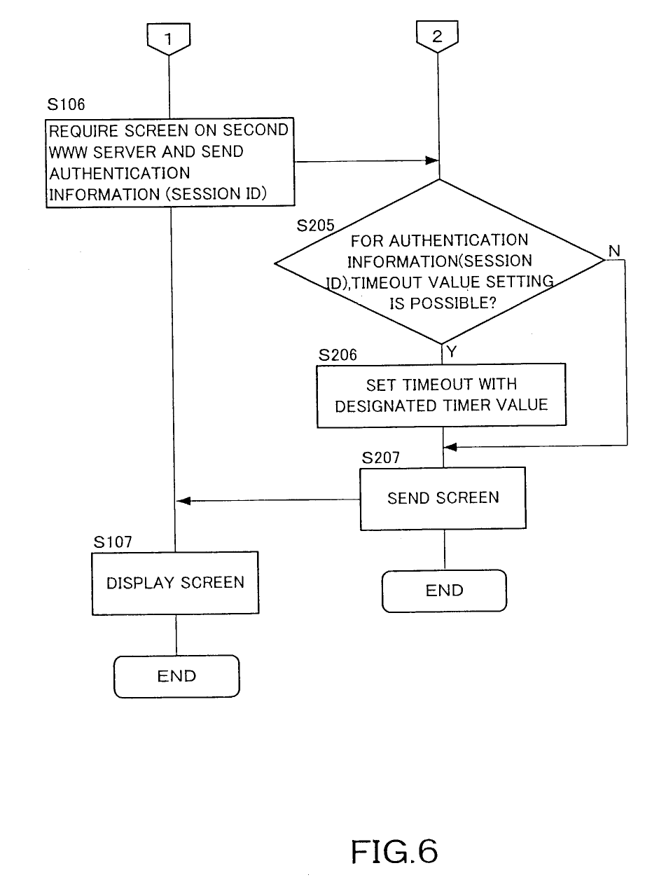

FIGS. 5 and 6 are flowcharts showing details of a procedure in the above described third phase. In the procedure, steps S105 and S204 in FIG. 5 are connected to steps S106 and S205 in FIG. 6, respectively.

In the flowcharts as shown in FIGS. 5 and 6, a flow on the left shows the procedure on the client, and a flow on the right shows the procedure on the second server. It should be noted that, though in the above described third phase, the information is sent and received via the first server, the procedure will be described below ignoring the existence of the first server.

The procedure is started if the user operates the client to select the link to the sub-homepage or the like. First on the client, a page name of a page configuring the sub-homepage to be accessed to display is acquired (step S101).

A timer value table shown as follows is retrieved with the acquired page name as a retrieval key, and the timer value corresponding to the page name is acquired (step S102).

TABLE 1

| | |
|---|---|
| Page Name | A |
| Timer Value | 30 minutes |
| Page Name | B |
| Timer Value | 5 minutes |
| Page Name | C |
| Timer Value | 30 minutes |

The timer value table as shown in TABLE 1 consists of a set of data in some pairs of two rows, which are Page Name in the upper row and Timer Value in the lower row. This timer value table is informed from the first server to the client if the authentication by the first server succeeds in the second phase in FIG. 4. In this timer value table, the page names of the pages configuring the sub-homepage on the second server and the timer values to be set for the pages are shown. In addition, the timer value (timeout time) in the main homepage is set here as 30 minutes. Accordingly, for the page having its page name of “A” or “C”, it is shown that the same timer value as the timer value in the main homepage is set, and for the page having its page name of “B”, it is shown that a different timer value than the timer value in the main homepage is set. If the timeout times always should be unified between the main homepage and the sub-homepage even in the case where a page is displayed with very important personal information, it may be a security problem. So this timer value table is prepared so that another timeout time may be set exceptionally for such a page.

If the timer value is acquired from the timer value table as described above, the client requires an authentication screen of the second server, and also requests the second server to set the acquired timer value to be used in the timeout process (step S103).

In response to the process in step S103 by the client, the process on the second server is started, and first the designated timer value is stored on the memory (step S201). Then, an HTML document representing the authentication screen is sent to the client (step S202).

On the client side, the authentication screen represented by the HTML document sent from the second server is used to input the authentication ID, the password or the like, and the client requests the second server for the authentication by means of the authentication ID or the like (step S104).

On the second server side, the authentication ID, the password or the like is checked, and if the client passes the authentication, the client is authorized for the session ID to be used temporarily instead of the authentication ID or the like, and the session ID is sent to the client (step S203). In addition, the authentication ID, the session ID and the timer value setting possible/impossible information are stored in an authentication ID/session ID association table shown as follows (step S204).

TABLE 2

| Authentication ID | Session ID | Timer Setting |
|---|---|---|
| 012011 | 782101 | possible |
| 124531 | 782102 | impossible |
| 223026 | 782103 | possible |

In TABLE 2, an example of the authentication ID/session ID association table managed by the second server is shown. For example, it is shown that the client, which has passed the authentication based on the authentication ID of “012011”, is authorized for the session ID of “782101”. The access from this client with the session ID of “782101” is accepted without the authentication unless the client is deprived of the session ID. In addition, since the authentication ID of “012011” is associated with the timer value setting possible/impossible information of “possible”, the timer value setting requested by the client, which has sent this authentication ID, is turned to be effective, as will be described below. It should be noted that the timer value setting possible/impossible information may be obtained from a timer setting possible/impossible table shown as follows, which is previously prepared within the second server.

TABLE 3

| | Setting is |
|---|---|
| Authentication ID | Possible/Impossible |
| 012011 | possible |
| 124531 | impossible |
| 223026 | possible |

In the timer setting possible/impossible table as shown TABLE 3, the authentication ID and the timer value setting possible/impossible information are described to be associated with each other, and the table shows whether or not the user identified with the authentication ID is given authorization for the timer value setting. This timer setting possible/impossible table is provided for giving the authorization for the timer value setting only to the user who belongs to a company operating the above described main homepage or the like.

Thus, while the above described information is stored in the authentication ID/session ID association table on the second server side, the session ID is stored on the memory on the client side (step S105).

Then, a sub-homepage screen is required by the client of the second server, and also the session ID is sent (step S106).

On the second server side, the authentication ID/session ID association table as shown in TABLE 2 is referred to and it is determined whether or not the possible/impossible information associated with the session ID is “possible” (step S205). If the information is determined as “possible”, the timer value stored in the above described step S201, which is designated by the client, is set as the timeout time (step S206). Such a process for setting the timer value is performed when the request for the screen with the session ID is sent for the first time.

Then, an HTML document representing the required screen is sent from the second server to the client (step S207), and on the client side, the screen is displayed based on the HTML document (step S107).

The timeout times are unified by the procedure as described above so that a stronger sense of unity is provided between the main homepage and the sub-homepage.

Hereinafter, the operation and an effect of the timeout management system of the present embodiment will be described using a specific screen example.

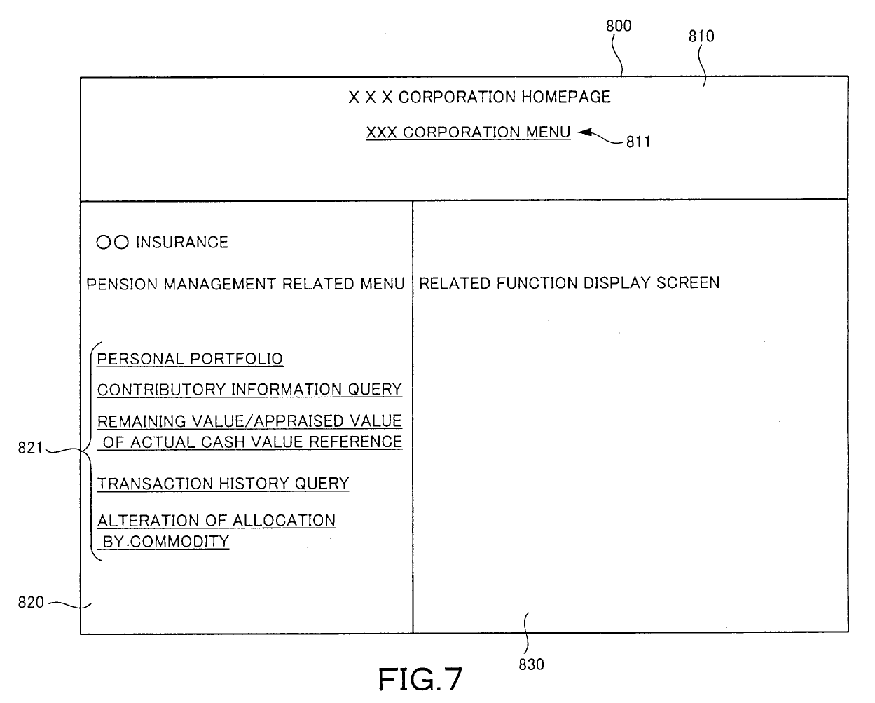

FIG. 7 shows a basic configuration of the screen displayed on the client.

In FIG. 7, a screen 800 of the main homepage on the first server is produced in a so-called frame form, with a first frame 810, a second frame 820 and a third frame 830. In addition, the screen 800 also has an invisible fourth frame as will be described below.

The first server is a server of XXX Corporation, and a homepage of XXX Corporation is linked to a homepage of ◯◯ Insurance which is affiliated with XXX Corporation.

In the first frame 810, a logo of the homepage of XXX Corporation and a link 811 for invoking a top menu of the homepage of XXX Corporation are constantly displayed.

In the second frame 820, which is a frame for displaying a menu, a menu 821 linked to each page configuring the homepage of ◯◯ Insurance is displayed in FIG. 7. When an item in the menu 821 is clicked, the menu of the item is displayed in the second frame 820, and when the link 811 in the first frame 810 is clicked, the top menu of the homepage of XXX Corporation is displayed in the second frame 820.

The third frame 830 is used as a related function display screen, in which each page configuring the main homepage or the sub-homepage is displayed, if the item in the menu 821 is clicked in the second frame 820.

Both of the homepage of XXX Corporation and the homepage of ◯◯ Insurance are Web sites which require the user authentication, and the timeout time is set for each of their WWW servers. For example, the timeout time for the WWW server of XXX Corporation is 30 minutes, and the default timeout time of the WWW server of ◯◯ Insurance is 5 minutes.

Authorization for invoking such a screen 800 is given to an employee in XXX Corporation, and the employee in XXX Corporation operates the above described client to perform the login to the server of XXX Corporation (the first server).

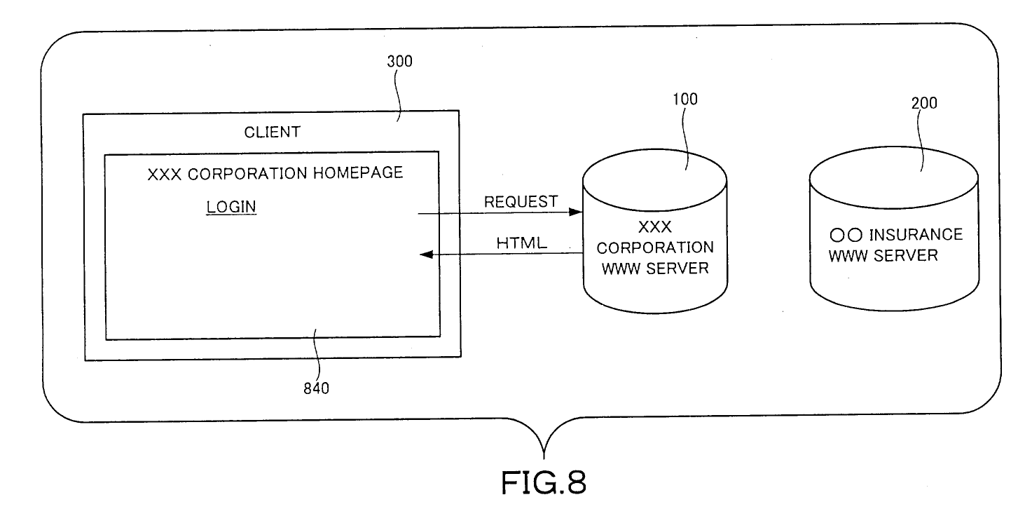

FIG. 8 shows the login state.

When the employee in XXX Corporation operates the client 300 and causes the first server 100 operated by XXX Corporation to send a “request” for requiring a login screen, an HTML document representing the login screen is returned from the first server 100 and a login screen 840 is displayed on the client 300. The above described employee performs an authentication operation using the authentication ID, the password or the like via the login screen 840, and goes into the login state in which the employee may freely access the homepage of XXX Corporation.

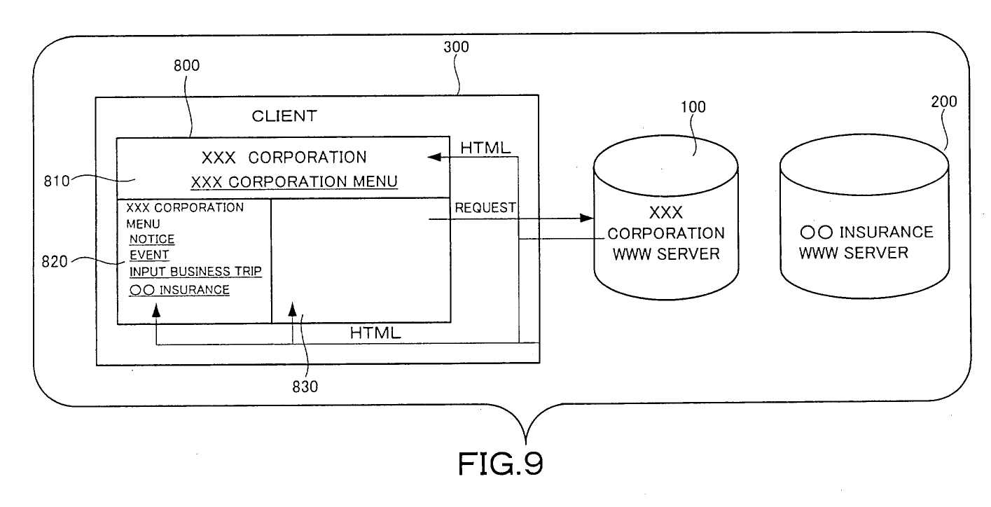

FIG. 9 shows the login state only with respect to the first server.

On the client 300, the screen 800 in the frame form as described with respect to FIG. 7 is displayed. In each of the frames 810, 820 and 830 of this screen, the menu represented by the HTML document obtained from the first server 100 or the like is displayed.

When the link of ◯◯ Insurance provided in the screen 800 displayed as described above is accessed, the login screen for performing the login to the second server 200 is displayed on the first access, the login operation is performed via the login screen, and it goes into the login state also with respect to the second server 200. When it goes into the login state also with respect to the second server 200 as described above, the page configuring the homepage of ◯◯ Insurance is displayed in the second frame 820 or the third frame 830.

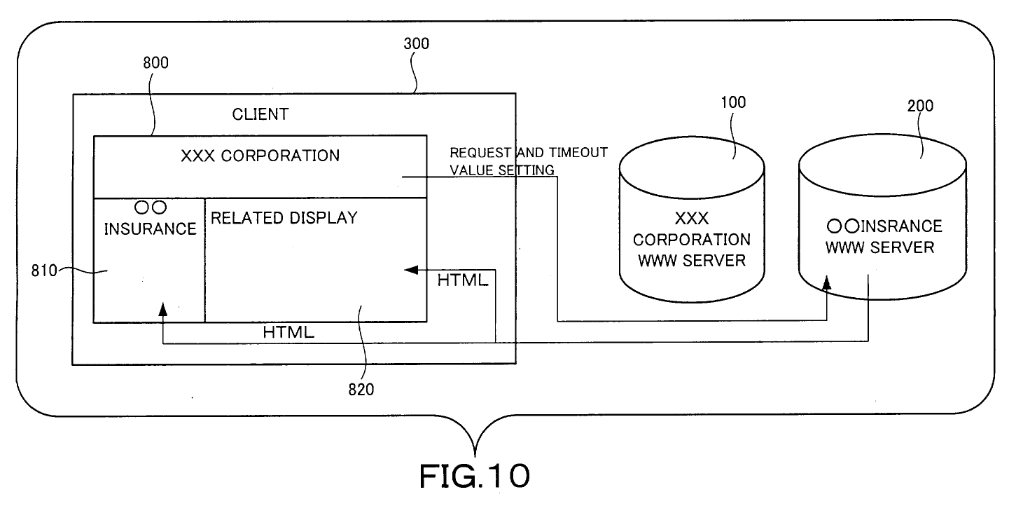

FIG. 10 shows the login state also with respect to a second server 200.

In the second frame 820 and the third frame 830 configuring the screen 800 displayed on the client 300, the menu represented by the HTML document obtained from the second server 200 for the “request” from the client 300, or the like are displayed. In addition, when the login is performed, in principle, the same timeout time as the timeout time in the first server 100 of XXX Corporation is set for the second server of ◯◯ Insurance, as described above.

When it is in the login state on both of the first server 100 and the second server 200 as described above, it is assumed that, for example, the menu of XXX Corporation in the first frame 810 is accessed to open the homepage of XXX Corporation, and that an operation for accessing only the first server 100 is performed.

The homepage of XXX Corporation is defined to send a dummy “request” to the second server 200 of ◯◯ Insurance, when there is any access with respect to the homepage of XXX Corporation while the second server 200 of ◯◯ Insurance is in the login state. Specifically, for example, in an HTML document for refreshing the screen 800, a statement for instructing the access with respect to the second server 200 of ◯◯ Insurance is included, and when the client 300 receives the HTML document including the statement and the browser interprets the statement, the “request” is sent to the second server 200 of ◯◯ Insurance. This operation is performed in order to synchronize a start of counting the timeout time in the second server of ◯◯ Insurance with a start of counting the timeout time in the first server of XXX Corporation, so that it may appear as if a single timeout process is performed as a whole.

With a current Web interface, even with respect to such a dummy “request”, the second server 200, which has received the “request”, should surely return the HTML document. In the screen 800 of the homepage of XXX Corporation, the fourth frame is defined for displaying the page represented by such an HTML document returned in response to the dummy “request”.

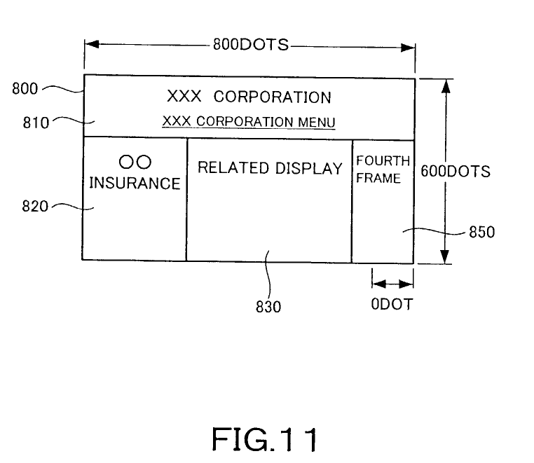

FIG. 11 shows the fourth frame.

The size of the screen 800 of the homepage of XXX Corporation is defined such as 800 dots in the width and 600 dots in the height. With respect to the size of the screen 800, each size of the first frame 810, the second frame 820 and the third frame 830 as described above is also appropriately defined. Furthermore, a fourth frame 850 is also defined as 0 dot in the width. Though the fourth frame 850 is represented as if it has some width for convenience only for showing it in FIG. 11, the fourth frame 850 has indeed 0 dot in the width so that it becomes the invisible region in which the user cannot recognize its existence in appearance at all. In the fourth frame 850 configuring such an invisible region, the page returned from the second server in response to the dummy “request” is displayed.

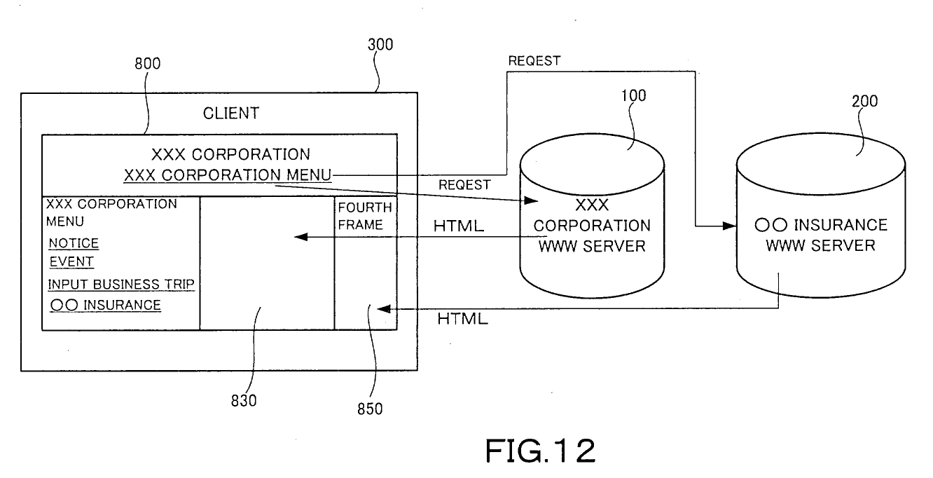

FIG. 12 shows a state in which the fourth frame is utilized.

In FIG. 12, a “request”, for example, for requiring the menu of the homepage of XXX Corporation, has been sent from the client 300 to the first server 100. Then an HTML document representing the required menu or the like is returned from the first server 100, and the HTML document is displayed, for example, in the third frame 830 or the like. In addition, the dummy “request” has been sent from the client 300 to the second server 200, and then the page represented by the HTML document returned in response to the dummy “request” is displayed in the fourth frame 850. Since the fourth frame forms the invisible region, the existence of the HTML document returned in response to the dummy “request” is hidden from eyes of the user, so that the user may naturally feel as if the user utilizes the homepage of XXX Corporation and the homepage of ◯◯ Insurance as one as a whole.

It should be noted that, though in the above described embodiment, the WWW server is shown as an example of the timeout management server of the present invention, the timeout management server of the present invention may be any server for managing the timeout process, and is not limited to the WWW server.

In addition, in the above described embodiment, the process for, in principle, unifying the timeout times between the first server and the second server is performed. However in the present invention, the process for unifying the timeout times is not necessarily needed, and the timeout process may be performed with the individual timeout time depending on each of the first server and the second server.

In addition, in the above described embodiment, an example is shown in which the main homepage is linked to a single sub-homepage. However, the present invention may also be applied to the case where the main homepage is linked to a plurality of sub-homepages.

In addition, in the above described embodiment, the browser on the client is utilized to issue the dummy “request” to the other server. However in the present invention, one timeout management server may directly access the other timeout management server.

In addition, in the above described embodiment, a system in a form is illustrated in which the client performs the login explicitly to both of the first server and the second server. However, the present invention may also be applied to a system in a form in which, for example, the first server performs the login to the second server on behalf of the client.

What is claimed is:

1. A timeout management system comprising:
a plurality of timeout management servers for providing a service to an access side in response to an access via a communication network based on a temporary access right, and also depriving of the access right when the access based on the access right halts for a predetermined timeout time since a last access;
a client holding said access right in parallel with respect to said plurality of timeout management servers; and
an access occurrence section for, in response to the access by said client with respect to one timeout management server of said plurality of timeout management servers, based on said access right of the client, causing the access to occur with respect to the other timeout management server besides the one timeout management server of said plurality of timeout management servers.

2. The timeout management system according to claim 1, wherein said access occurrence section exists in said timeout management server to perform the access with respect to the other timeout management server by means of said client.

3. The timeout management system according to claim 1, further comprising a timeout time unification section for altering the respective timeout times in said plurality of timeout management servers so as to be coincident with one another.

4. The timeout management system according to claim 3, wherein if the service provided by said timeout management server is the service of a particular type, said timeout time unification section sets the timeout time as a different timeout time than the timeout time unified among the plurality of timeout management servers.

5. The timeout management system according to claim 3, wherein said timeout time unification section alters the timeout time if an authentication ID obtained from said client is a particular authentication ID.

6. A timeout management server comprising:
an access authorization section for authorizing a client which has issued an application, for a temporary access right, in response to the application via a communication network;
a service providing section for providing a service to the client in response to an access by the client holding said access right via the communication network; and
a timeout process section for, when the access based on the access right authorized for a client by said access authorization section halts for a predetermined timeout time since a last access, depriving the client of the access right,
wherein the timeout management server includes an access occurrence section for, in response to the access with respect to said service providing section by the client which said access authorization section authorizes for the temporary access right while the other timeout management server also authorizes for the temporary access right, based on the access right of the client, causing the access to occur with respect to the other timeout management server.

7. A timeout management program storage medium incorporated in a computer, the timeout management program storage medium having stored a timeout management program for operating the computer as a timeout management server, the timeout management server comprising:
an access authorization section for authorizing a client which has issued an application, for a temporary access right, in response to the application via a communication network;
a service providing section for providing a service to the client in response to an access by the client holding said access right via the communication network; and
a timeout process section for, when the access based on the access right authorized for a client by said access authorization section halts for a predetermined timeout time since a last access, depriving the client of the access right,
wherein the timeout management program storage medium stores the timeout management program for operating said computer as the timeout management server, the timeout management server including an access occurrence section for, in response to the access with respect to said service providing section by the client which said access authorization section authorizes for the temporary access right while the other timeout management server also authorizes for the temporary access right, based on the access right of the client, causing the access to occur with respect to the other timeout management server.
